(19) United States
(12) Patent Application Publication
(10) Pub. No.: US 2002/0000141 A1
(43) Pub. Date: Jan. 3, 2002

(54) Live center an HSK taper shank actuated by a manual clamping device

(76) Inventor: James Dale McMillian, Houston, TX (US)

Correspondence Address: Wendy K. Buskop, Buskop Law Groug, P.C., Suite 500, 1717 St. James Place, Houston, TX, 77056, US

(21) Appl. No.: 09/810,642

(22) Filed: Mar. 16, 2001

Related U.S. Application Data
(60) Provisional application No. 60/190,255, filed on Mar. 17, 2000.

(51) Int. Cl. B23B 23/00; B23B 23/04

(52) U.S. Cl. 82/148; 82/150

(57) ABSTRACT

An improved live center for use with tapered shanks.

The present application is based on provisional patent application Serial No. 60/190,255, filed Mar. 17, 2000.

### BACKGROUND OF THE INVENTION

1. The Field of the Invention

The present invention relates to a class of tools, which are used on lathes and similar machines called work-holding parts. The present invention is an improved live center for use with tapered shanks.

2. The Prior Art

The lathe is a well-known device, which has a tailstock that can be adapted to a variety of uses.

HSK is an abbreviation designating a tooling interface standard, which was developed in Germany to define shanks, and spindle receivers. Industry began utilizing HSK tools in Europe during the early 1990's as a solution to tool holding problems. HSK work holding parts have become very popular for high-speed lathe and machine tooling applications. The HSK spindle is now considered the standard in many automotive, aerospace and aviation companies.

With the need for higher speeds, the tooling system has needed a method to maintain rigidity and yet achieve high accuracy. However, the speeds have been known to cause deflections and deformations in the machine business. High speeds cause spindles to widen. The steep tapers moves further into the spindle and causes problems after spindles stop. The contact of the HSK tools prevents which widening of the spindle, and the centrifugal forces press the typical HSK clamping unit against the outside of the spindle, causing improved rigidity. Details on the HSK industry can be found in the HSK Handbook, which as developed in consideration of the ANSI standards (the third angle of projection) available from Intelligent Concept, of West Bloomfield, Mich. and is hereby incorporated by reference.

Lathes and machining centers use, in the tailstock, either dead centers or live centers. The center used dictates the taper accuracy and diameter. It is an object of the present invention to provide a quickly replaceable, high tolerance live center which is compatible with HSK clamping technology so that fast machines can produce more accurate pieces with fewer deflections and deformations in the spinning process. Lathes and turning machines, which would be able to use the present invention, include machines available from Yamazaki Machinery of Worcester, UK, Cincinnati Machine of Birmingham, UK, and Bridgeport Machines of Leicester UK, all of which produce high speed turning machines. The present invention provides bearing inside the taper of the tapered shank to provide a tool capable of an accurate and fast depth of cut while minimizing deflections.

### SUMMARY OF THE INVENTION

An object of the present invention is to providing a tool, which can be quickly replaced if the machine becomes inoperative.

The present invention is a live center mounted on a manual-clamping cartridge, which is further on a HSK taper. The invention has a unique radial access hole, which can enable the user to provide a ¼ turn to provide full torque and interface for the taper. When full torque is enabling, the bearing capacity is increased, and accordingly, the rigidity of the self-contained tailstock will improve.

Further novel features and other objects of this invention will become apparent to those skilled in the art from the following detailed description, discussion and claims taken in conjunction with the accompanying drawings.

### BRIEF DESCRIPTION OF THE DRAWINGS

In the detailed description of the preferred embodiments of the invention presented below, reference is made to the accompanying drawings, in which:

FIG. 1 is a side, partially schematic plan view of the live center of the present invention;

FIG. 2 is a cross sectional view of an alternative spindle shape for the live center of the present invention;

FIG. 3 is a cross sectional view of a third spindle shape for the live center of the present invention;

FIG. 4 is a cross sectional view of a standard spindle shape for the live center of the present invention;

FIG. 5 is a cross sectional view of the most preferred embodiment of the present invention;

FIG. 6 is a cross sectional view of the self-contained live tail stock cartridge type called the “quill”.

### DETAILED DESCRIPTION OF THE PREFERRED EMBODIMENTS

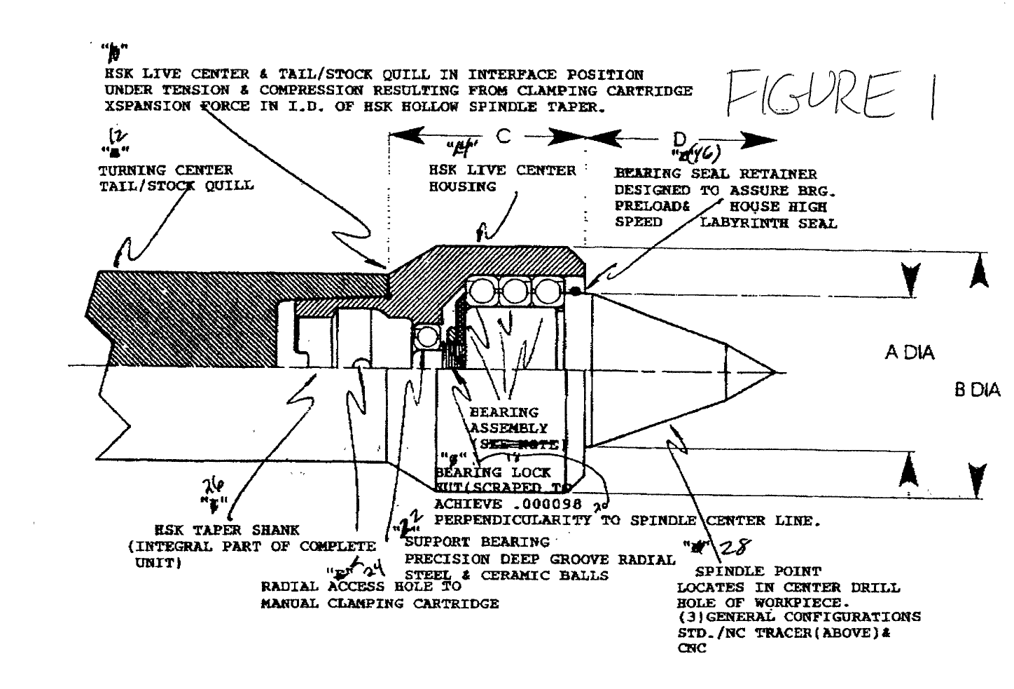

The present invention has been developed to provide increased durability and performance for live centers, which are used in cutting machines. The present invention has a unique design and utilizes unique ball bearings, which enable the resulting assemblage to have less thermal expansion, corrosion and electrical resistance to eliminate arcing in harsh environment, and lighter weight to decrease centrifugal forces on the bearing. FIG. 1 shows (10) a live center and a tail stock, which is also known as a “quill” in the interface position under tension and compression which results from clamping a cartridge expansion force in the inner diameter of an HSK hollow spindle taper. The tail stock quill has a turning center (12). The HSK live center housing is shown as (14). A bearing seal retainer (16) is designed to assure BRG preloaded and House High speed labyrinth seals. The bearing assembly (18) comprises bearing lock nuts (20) which are scraped to achieve a 0.000098 perpendicularity to the spindle center line, are connected to support bearing (22) which is a radial precision deep groove of steel which contains ceramic balls. Radial access hole (24) provides access to the manual-clamping cartridge. Adjacent to the radial access hole (24) is the HSK taper shank (26), which is an integral part of the complete unit.

At the opposite end of the HSK taper shank (26) is the spindle point (28), which locates in the center drill hole of the work piece.

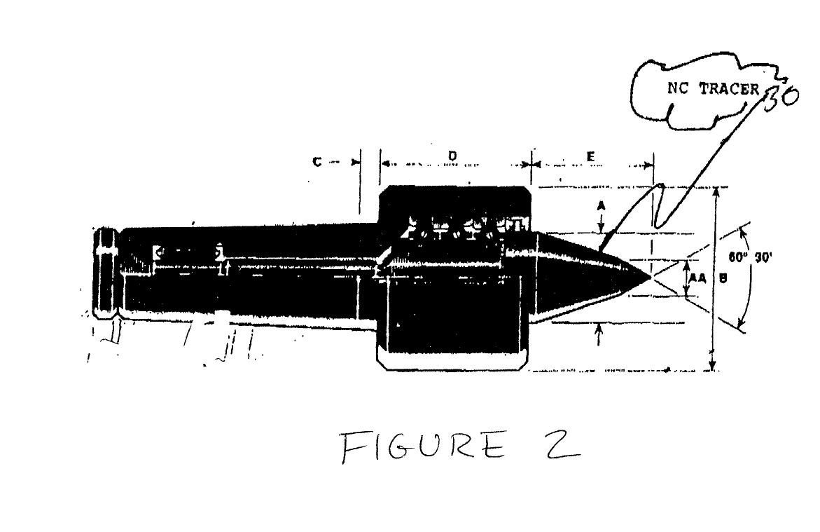

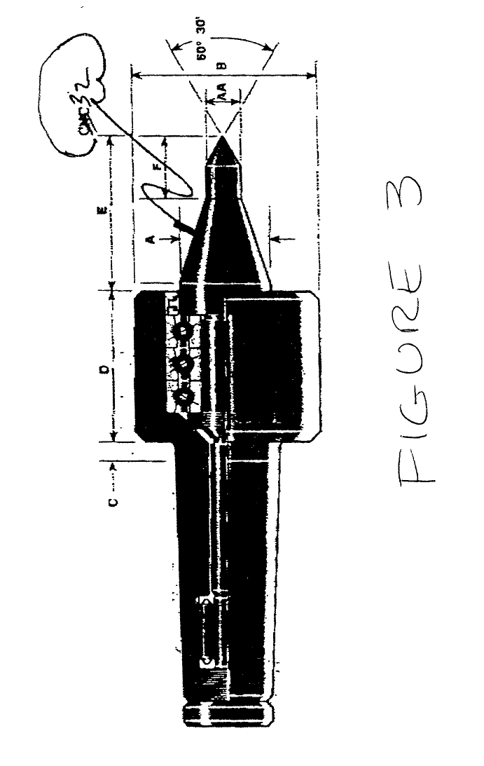

FIG. 2 shows an alternative spindle point (30), also known in the business as an NC Tracer, which can be used instead of the spindle point (28) shown in FIG. 1. Also within the scope of the present invention is the use of yet a third spindle point (32) shown in FIG. 3. The advantages of the two alternative spindles are that the bearing selection can be designed to resist radial and axial deflection; a high-speed anticontaminant centrifugal purge seal can be used. The RPM of the two alternative tapers provide ranges, which are compatible with the latest turning technology.

Dimensions for the spindle illustrated in FIG. 3 can be:

“A” is the diameter of the spindle (102);

“AA” is the working diameter of the CNC spindle point (104);

“B” is the body diameter of the bearing housing (106);

“C” is the gauge-line stand-off of the body and quill (108);

“D” is the length of the main body bearing housing (110);

“E” is the spindle projection from the housing face to point (112);

“F” is the length of the working diameter of CNC spindle point (114);

The following table provides the bearing load and operational RPM for the spindles given each of the dimensions listed:

| | Bearing | | | | | | | | |
|---|---|---|---|---|---|---|---|---|---|
| | Load | | | | | | | | |
| | Rating | Operational | | | | | | | |
| Model/Taper | (Dynamic) | RPM | | | | | | | |
| (Morse)* | ** | (Max) | A | AA | B | C | D | E | F |
| N C X 2 0 2 * / | 2,500# | 8,500 | ⅝″ | ⅜″ | 1⅝″ | ¼″ | 1 11/16″ | 1⅜″ | ⅝″ |
| N C X S 2 0 2 | | | | | | | | | |
| N C X 2 0 3 * / | 2,500# | 8,500 | ⅝″ | ⅜″ | 1⅝″ | ¼″ | 1 11/16″ | 1⅜″ | ⅝″ |
| N C X S 2 0 3 | | | | | | | | | |
| N C X 3 0 3 * / | 4,500# | 7,500 | 29/32″ | ½″ | 2 3/16″ | 5/16″ | 2 7/16″ | 1⅝″ | ⅞″ |
| N C X S 3 0 3 | | | | | | | | | |
| N C X 3 0 4 * / | 4,500# | 7,500 | 29/32″ | ½″ | 2 3/16″ | 5/16″ | 2 7/16″ | 1⅝″ | ⅞″ |
| N C X S 3 0 4 | | | | | | | | | |
| N C X 4 0 4 * / | 10,000# | 6,000 | 1 1/16″ | 9/16″ | 2 11/16″ | ⅜″ | 2 11/16″ | ⅛″ | 1″ |
| N C X S 4 0 4 | | | | | | | | | |
| N C X 4 0 5 */ | 10,000# | 6,000 | 1 1/16″ | 9/16″ | 2 11/16″ | ⅜″ | 2 11/16″ | ⅛″ | 1″ |
| N C X S 4 0 5 | | | | | | | | | |
| N C X 5 0 5 * / | 16,000# | 4,500 | 1½″ | ⅝″ | 3⅝″ | ⅜″ | 3⅜″ | 2½″ | 1″ |
| N C X S 5 0 5 | | | | | | | | | |
| N C X 5 1 5 * / | 20,000# | 3,000 | 2″ | 1″ | 4½″ | 7/16″ | 4⅛″ | 3⅜″ | 1½″ |
| N C X S 5 1 5 | | | | | | | | | |
| N C X 5 1 6 * / | 20,000# | 3,000 | 2″ | 1″ | 4½″ | 7/16″ | 4⅛″ | 3⅜″ | 1½″ |
| N C X S 5 1 6 | | | | | | | | | |
| N C X 6 0 6 * / | 30,000# | 2,500 | 2½″ | 1¼″ | 4½″ | ½″ | 4⅝″ | 3½″ | 1¾″ |
| N C X S 6 0 6 | | | | | | | | | |

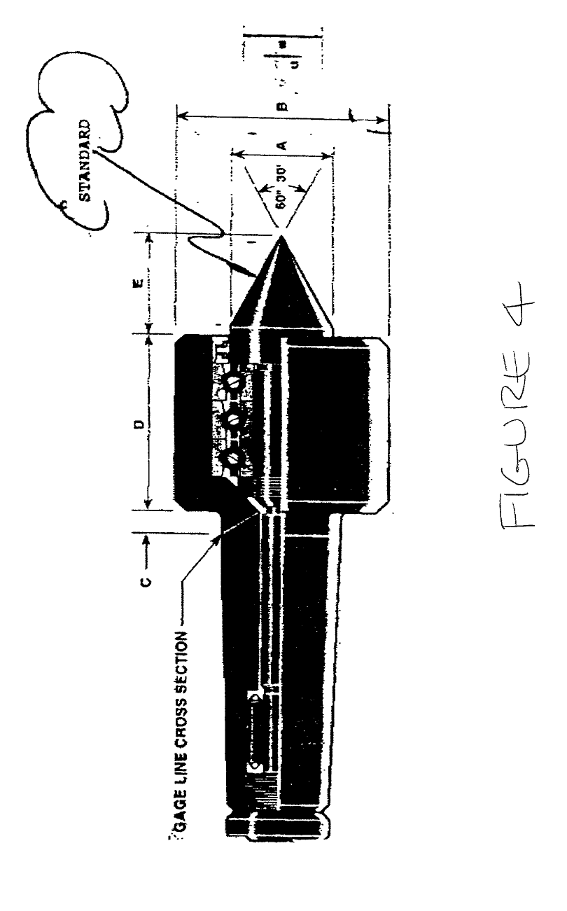

FIG. 4 shows a standard spindle nose, which can be used, within the scope of the present invention.

The dimensions of the standard nose are as follows:

“A” is the diameter of the spindle (202);

“AA” is the working diameter of the bearing housing (204);

“B” is the body diameter of the bearing housing (206);

“C” is the gauge-line stand-off of the body and quill (208);

“D” is the length of the main body bearing housing (210);

“E” is the spindle projection from housing face to point (212);

The following table provides the bearing load and operational RPM for the spindles given each of the dimensions listed:

| | Bearing Load | Operational | | | | | |
|---|---|---|---|---|---|---|---|
| Model/Taper | Rating | RPM | | | | | |
| (Morse)* | (Dynamic)** | (Max) | A | B | C | D | E |
| X R 2 0 2 / | 2,500# | 8,500 | ⅝″ | 1⅝″ | ¼″ | 1 11/16″ | 1″ |
| G X R 2 0 2 * | | | | | | | |
| X R 2 0 3 / | 2,500# | 8,500 | ⅝″ | 1⅝″ | ¼″ | 1 11/16″ | 1″ |
| G X R 2 0 3 * | | | | | | | |
| X R 3 0 3 / | 4,500# | 7,500 | 29/32″ | 2 3/16″ | 5/16″ | 2 7/16″ | 1⅛″ |
| G X R 3 0 3 * | | | | | | | |
| X R 3 0 4 / | 4,500# | 7,500 | 29/32″ | 2 3/16″ | 5/16″ | 2 7/16″ | 1⅛″ |
| G X R 3 0 4 * | | | | | | | |
| X R 4 0 4 / | 10,000# | 6,000 | 1 1/16″ | 2 11/16″ | ⅜″ | 2 11/16″ | 1¼″ |
| G X R 4 0 4 * | | | | | | | |
| X R 4 0 5 / | 10,000# | 6,000 | 1 1/16″ | 2 11/16″ | ⅜″ | 2 11/16″ | 1¼″ |
| G X R 4 0 5 * | | | | | | | |
| X R 5 0 5 / | 16,000# | 4,000 | 1½″ | 3⅝″ | ⅜″ | 3⅜″ | 1⅝″ |
| G X R 5 0 5 * | | | | | | | |
| X R 5 1 5 / | 20,000# | 3,000 | 2″ | 4½″ | 7/16″ | 4⅛″ | 2⅛″ |
| G X R 5 1 5 * | | | | | | | |
| X R 5 1 6 / | 20,000# | 3,000 | 2″ | 4½″ | 7/16″ | 4⅛″ | 2⅛″ |
| G X R 5 1 6 * | | | | | | | |
| X R 6 0 6 / | 30,000# | 2,500 | 2½″ | 5½″ | ½″ | 4 19/32″ | 2¾″ |
| G X R 6 0 6 * | | | | | | | |
| X R 6 0 7 / | 30,000# | 2,500 | 2½″ | 5½″ | ½″ | 4 19/32″ | 2¾″ |
| G X R 6 0 7 * | | | | | | | |
| X R 6 1 6 / | 45,000# | 1,700 | 3″ | 6⅝″ | 11/16″ | 5 1/16″ | 3⅛″ |
| G X R 6 1 6 * | | | | | | | |
| X R 6 1 7 / | 45,000# | 1,700 | 3″ | 6⅝″ | 11/16″ | 5 1/16″ | 3⅛″ |
| G X R 6 1 7 * | | | | | | | |

Operator removes live center from tool center cabinet. Engages hollow spindle taper of live center with clamping cartridge in I.D. of the machine tool quill. Actuation is performed by placing an allen wrench in the radial access hole on the O.D. of the quill and rotating ninety (90) degrees to expand clamping cartridge and achieve interface.

The above example shows how the present invention can be installed. The invention has doubled the speed and feed rates to materials to be cut. Programmable tail stocks and workpiece elongation subject the live center bearings to high forces. The ceramic balls used in the bearing assemble enhance the live centers resistance to compression and thermal expansion. The unit can endure high temperatures with no change in tolerances from static to dynamic speeds and loads. In addition, it has been tested and the present invention provides higher durability, even when the seals of the unit deteriorate and coolant contamination occurs in the bearing housing. The ceramic balls hold up to abrasive and coolant contamination in the lubrication for long periods of time.

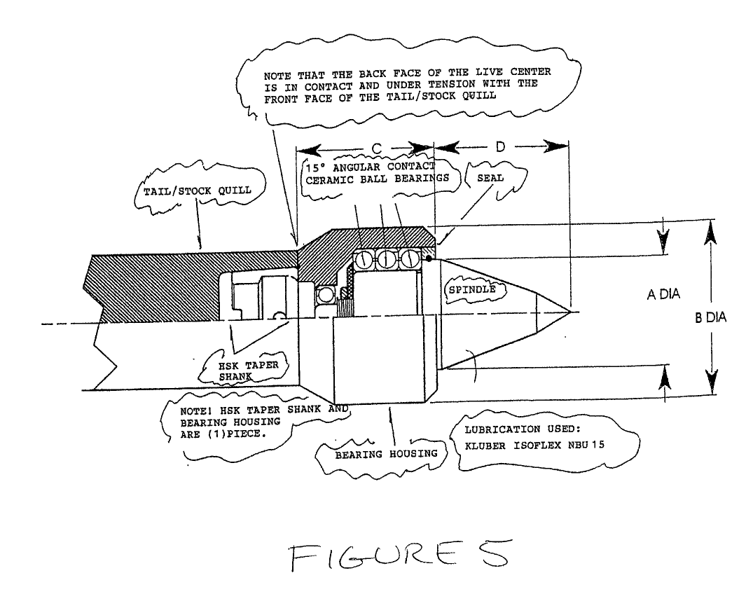

In the most preferred embodiment, shown as FIG. 5, the ceramic ball bearings have a 15-degree angle contact. Also in the preferred embodiment, the HSK taper shank and bearing housing are one piece. Additionally, the preferred lubricant used is a KLUBER ISOFLEX NBU 15 for cooling the live center.

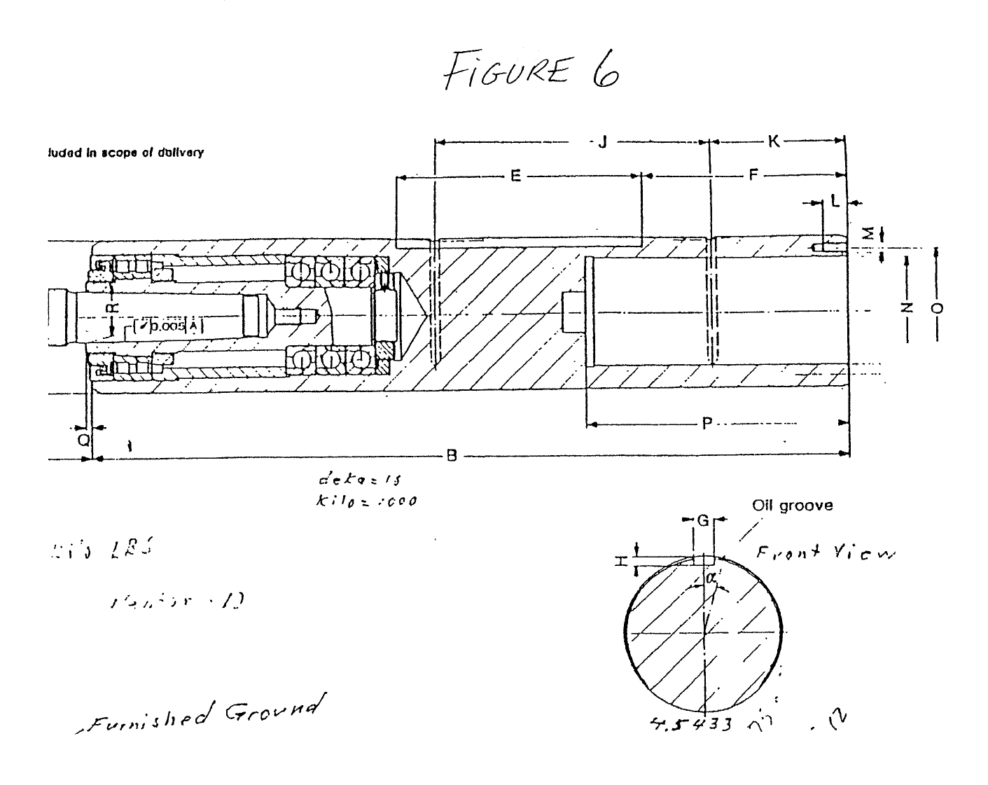

FIG. 6 is the cross sectional view of the live center on the tailstock.

The dimensions are shown as follows:

A is the HSK live center and tail/stock quill in interface position under tension and compression resulting from clamping cartridge expansion force in I.D. of HSK hollow spindle taper;

B is the turning center tail/stock quill;

C is the HSK live center housing;

D is the bearing seal retainer designed to assure BRG. Preload and house high speed labyrinth seal;

E is the HSK taper shank (integral part of complete unit);

F is the support bearing precision deep groove radial steel and ceramic balls;

G is the bearing lock nut (scraped to achieve 0.000098 perpendicularity to spindle center line;

H is the spindle point located in center drill hole of workpiece.

In addition, the following key parts are noted: clamping cartridge assembly, expanding lock lugs, adjustment screws, coolant seal o-ring, bayonet locking lugs, lubrication, kluber and the type isoflex and sonic.

The present invention preferably uses ball bearings which are ceramic, precision crafted with particular geometries and finishes, such as those available from Cerbec. Cerbec balls are available from Norton, of East Granby Conn.

The spindle points which are usable in the scope of the present invention include conventional spindle points, tracer/CNC spindle points, bull nose/pipe centers which use revolving heads and stationary bodies are considered usable within the scope of this invention.

The above, and other objects, features, advantages and embodiments of the invention, including other (i.e., additional) embodiments of the techniques discussed above may become apparent to one having skill in the art to which this invention most nearly pertains, and such other embodiments are deemed to be within the spirit and scope of the present invention.

What is claimed is:

1. A cutting tool for cutting work pieces comprising:
a tailstock;
a live center mounted on one end of said tail stock having a first and second end;
a taper assembly extending from said first ends those mates to a lathe;
a bearing housing attached to said second end of said live center;
a spindle disposed within said bearing housing;
a seal located in the front bearing retainer and the rear section of the clamping cartridge; and
at least three live center bearings disposed in said bearing housing wherein said live center bearings withstand axial forces of said tail stock pushing on said workpiece and the radial forces of the cutting tool on said workpiece without deflection of more than one degree (1 degree).

2. The cutting tool of claim 1, wherein said bearings are ceramic balls.

3. The cutting tool of claim 1, wherein said spindle has a shape selected from any one of the following:
standard point, designed for heavy loads, deep cuts and lower rpm ranges;
designed for medium cuts, higher rpm ranges and provisions for tool clearance; or
extremely high speeds, precision feeds indept of cut and special tool clearances.

4. The cutting tool of claim 1, wherein said live center is manually inserted into the tail/stock quill.

5. The cutting tool of claim 1, wherein said live center can be manually installed.

6. The cutting tool of claim 1, further comprising an HSK taper attached to the clamping cartridge of the machine quill tool.

7. A cutting tool of claim 1, further comprising a spindle selected from the group:
conventional live center, a tracer/CNC spindle point, and a bull nose/pipe center with revolving head and stationary body.
